(19) United States
(12) Patent Application Publication
(10) Pub. No.: US 2008/0309613 A1
(43) Pub. Date: Dec. 18, 2008

(54) ELECTROPHORETIC DISPLAY AND METHOD FOR MANUFACTURING THEREOF

(75) Inventor: Ju-Han BAE, Suwon-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/022,499

(22) Filed: Jan. 30, 2008

(30) Foreign Application Priority Data
Jun. 15, 2007 (KR) 10-2007-0059000

(51) Int. Cl. G09G 3/34

(52) U.S. Cl. 345/107

(57) ABSTRACT

An electrophoretic display includes a thin film transistor array panel including a first substrate, a gate line on the first substrate having a gate electrode, a gate insulating layer on the gate line, a semiconductor on the gate insulating layer, a data line including a source electrode and a drain electrode on the semiconductor or the gate insulating layer, a passivation layer covering the data line and having a first contact hole exposing the drain electrode, a storage electrode on the passivation layer, a color filter on the storage electrode and having a second contact hole exposing the first contact hole, and a pixel electrode on the color filter and connected to the drain electrode; a common electrode panel facing the thin film transistor array panel, and including a common electrode, and a electrophoretic member between the pixel electrode and the common electrode.

### CROSS-REFERENCE TO RELATED APPLICATION

This application claims priority from and the benefit of Korean Patent Application No. 10-2007-0059000, filed on Jun. 15, 2007, which is hereby incorporated by reference for all purposes as if fully set forth herein.

### BACKGROUND OF THE INVENTION

1. Field of the Invention

The present invention is related to an electrophoretic display and a manufacturing method thereof.

2. Discussion of the Background

An electrophoretic display includes two substrates having electrodes and electrophoretic particles disposed between the two substrates. The electrophoretic particles are charged with positive and negative electricity, and may have a color to display a color image. The electrophoretic display may display a color by rotating the electrophoretic particles or moving the electrophoretic particles between opposing electrodes according to an applied electric voltage. Alternatively, color filters may be used to display a color image.

However, it is difficult to align the electrophoretic panel and thin film transistor array panel when using a color filter, and there is a problem that the color filter may have the same size as the thin film transistor array panel. Furthermore, the electrophoretic members disposed between the electrodes are not regularly driven when driving a misaligned display device such that the screen becomes cloudy.

Also, the colored particles may be disposed on each pixel and a black color may be displayed when using the colored particles in the micro capsules.

The above information disclosed in this Background section is only for enhancement of understanding of the background of the invention and therefore it may contain information that does not form the prior art that is already known in this country to a person of ordinary skill in the art.

### SUMMARY OF THE INVENTION

This invention provides an electrophoretic display and a method for manufacturing the same to improve luminance and to display clear color images.

Additional features of the invention will be set forth in the description which follows, and in part will be apparent from the description, or may be learned by practice of the invention.

The present invention discloses an electrophoretic display including a thin film transistor array panel including a first insulating substrate, a gate line arranged on the first insulating substrate having a gate electrode, a gate insulating layer arranged on the gate line, a semiconductor arranged on the gate insulating layer, a data line including a source electrode and a drain electrode, the data line arranged on the semiconductor or the gate insulating layer, a passivation layer covering the data line and having a first contact hole exposing the drain electrode, a storage electrode arranged on the passivation layer, a color filter arranged on the storage electrode and having a second contact hole exposing the drain electrode through the first contact hole, and a pixel electrode arranged on the color filter and connected to the drain electrode. The electrophoretic display also includes a common electrode panel including a second insulating substrate facing the thin film transistor array panel, and a common electrode arranged on the second insulating substrate; and an electrophoretic member arranged between the pixel electrode and the common electrode.

The present invention also discloses a method for manufacturing an electrophoretic display including forming a thin film transistor array panel including forming a gate line, a semiconductor, and a data line on a first insulating substrate, forming a passivation layer and a storage electrode, the passivation layer to cover the data line, forming a color filter on the passivation layer and the storage electrode, and forming a pixel electrode on the color filter. The method also includes forming a common electrode panel including forming a common electrode on a second insulating substrate; and depositing an electrophoretic member on the common electrode, and connecting the common electrode panel to the thin film transistor array panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view of an electrophoretic display according to an exemplary embodiment of the present invention.

FIG. 2 is a cross-sectional view of the electrophoretic display illustrated in FIG. 1 taken along line II-II′.

FIG. 3 is a cross-sectional view of the electrophoretic display illustrated in FIG. 1 taken along line III-III′.

FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, and FIG. 19 are cross-sectional views of a manufacturing method for a thin film transistor array panel of the electrophoretic display illustrated in FIG. 1.

FIG. 20 is a cross-sectional view showing the disposed arrangement of the display panel according to the viewing direction when using the electrophoretic display according to an exemplary embodiment of the present invention.

FIG. 21 is a plan view of an electrophoretic display according to another exemplary embodiment of the present invention.

FIG. 22 is a cross-sectional view of the electrophoretic display illustrated in FIG. 21 taken along line XXII-XXII′.

FIG. 23 is a cross-sectional view of the electrophoretic display illustrated in FIG. 21 taken along line XXIII-XXIII′.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

Now, an electrophoretic display according to an exemplary embodiment of the present invention will be described in detail with the reference to the accompanying drawings.

### Exemplary Embodiment 1

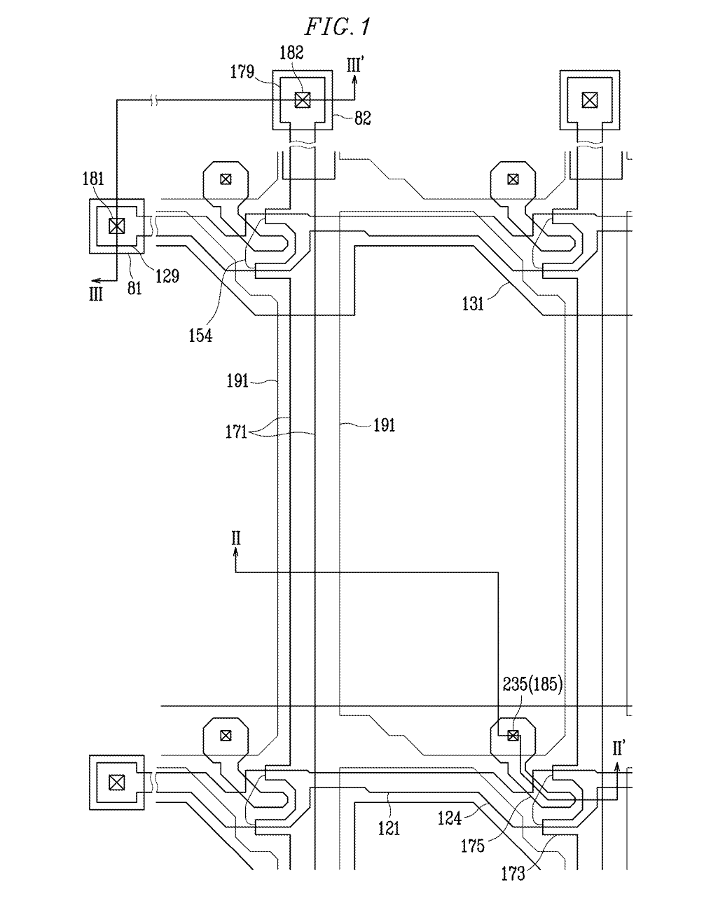

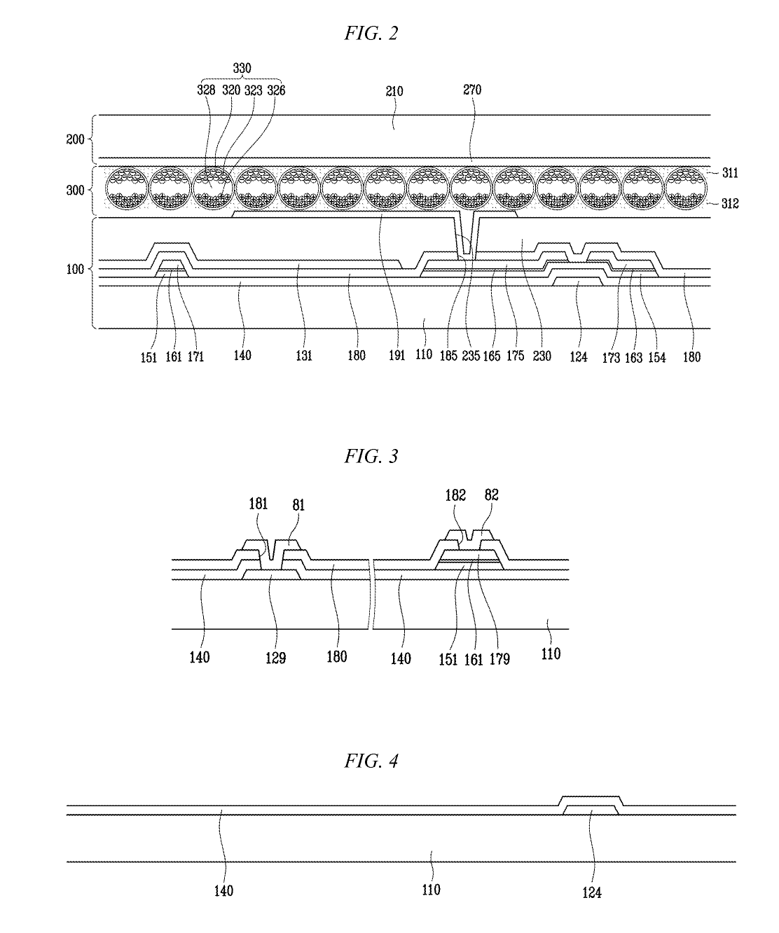

FIG. 1 is a plan view of an electrophoretic display according to an exemplary embodiment of the present invention. FIG. 2 is a cross-sectional view of the electrophoretic display illustrated in FIG. 1 taken along line II-II′. FIG. 3 is a cross-sectional view of the electrophoretic display illustrated in FIG. 1 taken along line III-III′.

Referring to FIG. 1, FIG. 2, and FIG. 3, an electrophoretic display according to an exemplary embodiment of the present invention includes a common electrode panel 200, a thin film transistor array panel 100 facing the common electrode panel 200, and an electrophoretic film 300 disposed between the thin film transistor array panel 100 and the common electrode panel 200. As shown in FIG. 2, the thin film transistor array panel 100 may be disposed closer to a viewer than the common electrode panel 200 if images are displayed by the electrophoretic display through the thin film transistor array panel 100.

First, the thin film transistor array panel 100 will be described with reference to FIG. 1, FIG. 2, and FIG. 3.

Gate lines 121 are formed on an insulation substrate 110. The gate lines 121 transmit gate signals, and extend in a horizontal direction. A gate line 121 includes gate electrodes 124 protruding downward and an end portion 129 having a large area for connection with another layer or a driving circuit.

The gate lines 121 may be made of an opaque metal having good light blocking characteristics such as chromium (Cr). Furthermore, the gate lines 121 may have a dual-layered structure including two conductive layers (not shown) having different physical properties. One of the two films may be a low resistivity metal such as an Al-containing metal, a Ag-containing metal, or a Cu-containing metal for reducing signal delay or voltage drop in the gate lines 121. The other film may be a material that has good physical, chemical, and electrical contact characteristics for contact with materials such as indium tin oxide (ITO) or indium zinc oxide (IZO). For example, the other film may be Cr, Mo, Mo alloys, Ta, or Ti.

The gate lines 121 may be chromium that is opaque and has good light blocking characteristics such that the gate lines 121 function as a light blocking layer. Furthermore, when forming multilayer gate lines 121, the lowest layer of the gate lines may be a metal that is opaque and has light blocking characteristics such as chromium. However, as explained above, the gate lines 121 may be made of various metals or conductors.

The lateral sides of the gate lines 121 are inclined relative to a surface of the substrate 110, and the inclination angle thereof may range from about 30 to about 80 degrees.

A gate insulating layer 140 may be made of silicon nitride (SiNx) or silicon oxide (SiOx) and is arranged on the gate lines 121.

Semiconductor lines 151 are arranged on the gate insulating layer 140. The semiconductor lines 151 extend in a vertical direction, and include protruded portions 154 extending toward the gate electrodes 124. As shown in FIG. 1, the semiconductor protruded portions 154 are exposed from data lines 171 and drain electrodes 175, and are disposed between source electrodes 173 and the drain electrodes 175.

Ohmic contact lines 161 and ohmic contact islands 165 are arranged on the semiconductor lines 151 including the semiconductor protruded portions 154. The ohmic contact lines 161 and ohmic contact islands 165 are only disposed between the semiconductor lines 151 and the data lines 171, the source electrodes 173, and the drain electrodes 175 to reduce the contact resistance therebetween. However, the ohmic contact lines 161 and ohmic contact islands 165 are not disposed on the semiconductor protruded portions 154 in a region corresponding to a channel region between the source electrodes 173 and the drain electrodes 175.

The ohmic contact lines 161 and ohmic contact islands 165 may be made of amorphous silicon, polysilicon, or silicide, which is doped with a high concentration of an n-type impurity such as phosphorus or a p-type impurity such as boron. The ohmic contact lines 161 include ohmic contact protruded portions 163, and the ohmic contact protruded portions 163 and the ohmic contact islands 165 are disposed in pairs on the semiconductor protruded portions 154 of the semiconductor lines 151 except in a region corresponding to a channel region between the source electrodes 173 and the drain electrodes 175.

The lateral sides of the ohmic contact lines 161 and ohmic contact islands 165 and the semiconductor lines 151 are inclined relative to a surface of the substrate 110, and the inclination angle thereof may range from about 30 to about 80 degrees.

Data lines 171 are arranged on the ohmic contact lines 161 and the ohmic contact islands 165, and on the gate insulating layer 140. The data lines 171 transmit data signals, and extend in a vertical direction and cross with the gate lines 121. A data line 171 includes source electrodes 173 extending toward the gate electrodes 124, and an end portion 179 having a wide area for connection with another layer or a driving circuit.

The drain electrodes 175 are separated from the source electrodes 173 and are disposed opposite the source electrodes 173 with reference to the gate electrodes 124.

Each drain electrode 175 includes a wide end portion, and a narrow end portion having a bar shape that is partially surrounded by a curved portion of the source electrode 173.

The data lines 171 and the drain electrodes 175 may an opaque metal having good light blocking characteristics such as chromium (Cr), or may be multi-layered structures including an opaque conductive layer having good light blocking characteristics and a conductive layer having low resistivity. Examples of the multi-layered structure include a two-layer structure including a lower chromium (or alloy) layer and an upper aluminum (or alloy) layer, and a three-layer structure including a lower chromium (or alloy) layer, a middle aluminum (or alloy) layer, and an upper chromium (or alloy) layer.

Therefore, the data lines 171 may function as a light blocking layer. Furthermore, when forming the data lines 171, the lowest layer of the data lines 171 may be made of an opaque metal having good light blocking characteristics such as chromium. However, as described above, the data lines 171 may be made of various metals or conductors.

The lateral sides of the drain electrodes 175 and the data lines 171 are inclined relative to a surface of the substrate 110, and the inclination angle thereof may range from about 30 to about 80 degrees.

A passivation layer 180 is arranged on the drain electrodes 175, the data lines 171, and the exposed semiconductor lines 151. The passivation layer 180 may be made of an inorganic insulator such as silicon nitride (SiNx) and silicon oxide (SiOx).

The passivation layer 180 has contact holes 182 and 185 respectively exposing the end portions 179 of the data lines 171 and the drain electrodes 175, and the passivation layer 180 and the gate insulating layer 140 both have contact holes 181 exposing the end portions 129 of the gate lines 121.

A storage electrode 131 is arranged in the horizontal direction parallel with the gate lines 121 and crossing with the data lines 171 on the passivation layer 180. The storage electrode 131 may occupy a large portion of a pixel region corresponding with a pixel electrode 191, as shown in FIG. 1 and described below in more detail, and may be made of a transparent conductive material such as ITO or IZO. Accordingly, the storage electrode 131 may not deteriorate the aperture ratio of the display device such that the aperture ratio of the electrophoretic display may be improved. Furthermore, the storage electrode 131 may have a wide enough area to form a storage capacitance. The thickness of the storage electrode 131 may be in the range of about 50 to 3000 angstroms, or in the range of about 50 to 1300 angstroms, or in the range of about 400 to 500 angstroms.

Alternatively, the storage electrodes 131 may be parallel to the data lines 171 and cross with the gate lines 121. Also, the storage electrodes 131 may be integrally formed in the entire display area enclosed by the gate lines 121 and the data lines 171. In this arrangement, the storage electrodes 131 may have openings to expose the contact holes 185. However, as shown in FIG. 1, the storage electrodes 131 may be arranged such that no contact holes are included in the storage electrodes 131.

Color filters 230 of red, green, and blue are arranged on the passivation layer 180 and the storage electrodes 131. The color filters 230 are not arranged on the common electrode panel 200, but on the thin film transistor array panel 100 as a color filter on array (COA) structure. Therefore, the difficulty in aligning the color filters 230 and pixel electrodes 191 may be reduced when assembling the thin film transistor array panel 100 and the common electrode panel 200. The color filters 230 have contact holes 235 exposing the contact holes 185 of the passivation layer 180.

The pixel electrodes 191 that may be made of a transparent conductive material such as ITO or IZO are arranged on the color filters 230. The pixel electrodes 191 are connected to the drain electrodes 175 through the contact holes 235 of the color filters 230 and the contact holes 185 of the passivation layer 180. Because the storage electrodes 131 are a transparent material, the pixel electrodes 191 may overlap the storage electrodes 131 to increase the storage capacitance. For example, a storage electrode 131 may overlap about 30% to 90% of the surface area of a pixel electrode 191.

Contact assistants 81 and 82 are arranged on the passivation layer 180 and are respectively connected to the end portion 129 of the gate line 121, and the end portion 179 of the data line 171.

The pixel electrodes 191 are adhered to electrophoretic members 330 of the common electrode panel 200 through a second adhesion member 312, as described in more detail below.

Second, the common electrode panel 200 will be described with the reference to FIG. 2.

The common electrode panel 200 includes an insulation substrate 210, which may be made of glass or plastic, and a common electrode 270, which may be made of a conductive material and more specifically an opaque metal having good light blocking characteristics such as chromium.

A first adhesion member 311 is arranged on the common electrode 270 for adhering the electrophoretic members 330 to the common electrode panel 200. The first adhesion member 311 may be a liquefied material or a film.

The electrophoretic members 330 are densely arranged on the first adhesion member 311. The electrophoretic members 330 may be made of a single layer or a multi-layer.

The electrophoretic members 330 include electrophoretic particles 323 and 326 respectively charged with negative and positive charges, and a dispersion medium 328 in which the electrophoretic particles 323 and 326 are dispersed, and a capsule 320 enclosing the negatively-charged electrophoretic particles 323, the positively-charged electrophoretic particles 326, and the dispersion medium 328. The negatively-charged electrophoretic particles 323 may display a black color, and the positively-charged electrophoretic particles 323 may display a white color.

The second adhesion member 312 for adhering the electrophoretic members 330 of the common electrode panel 200 to the thin film transistor array panel 100 is arranged on the electrophoretic members 330. The second adhesion member 312 may be a liquefied material or a film.

The common electrode panel 200 including the electrophoretic members 330 is connected to the thin film transistor array panel 100 through the second adhesion member 312.

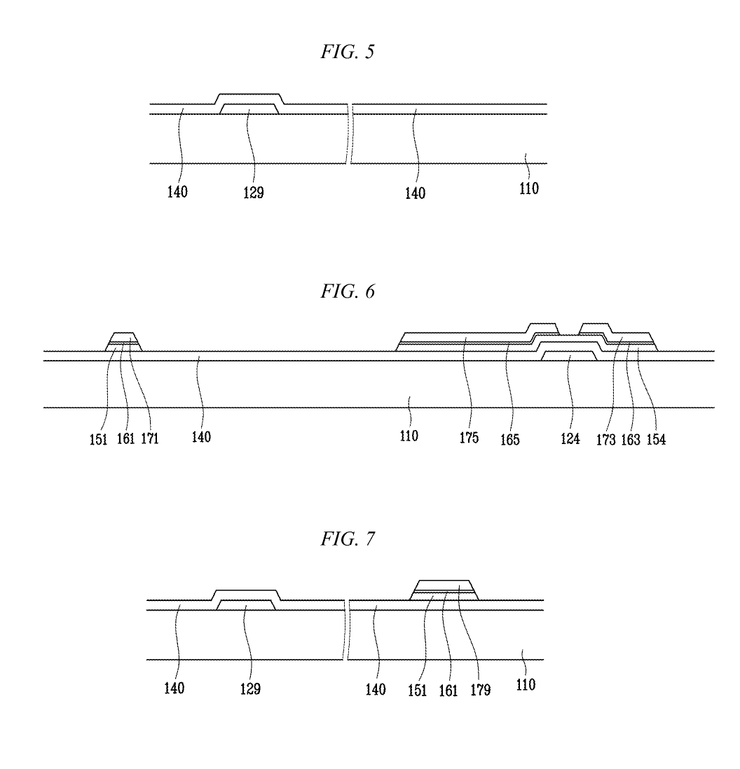

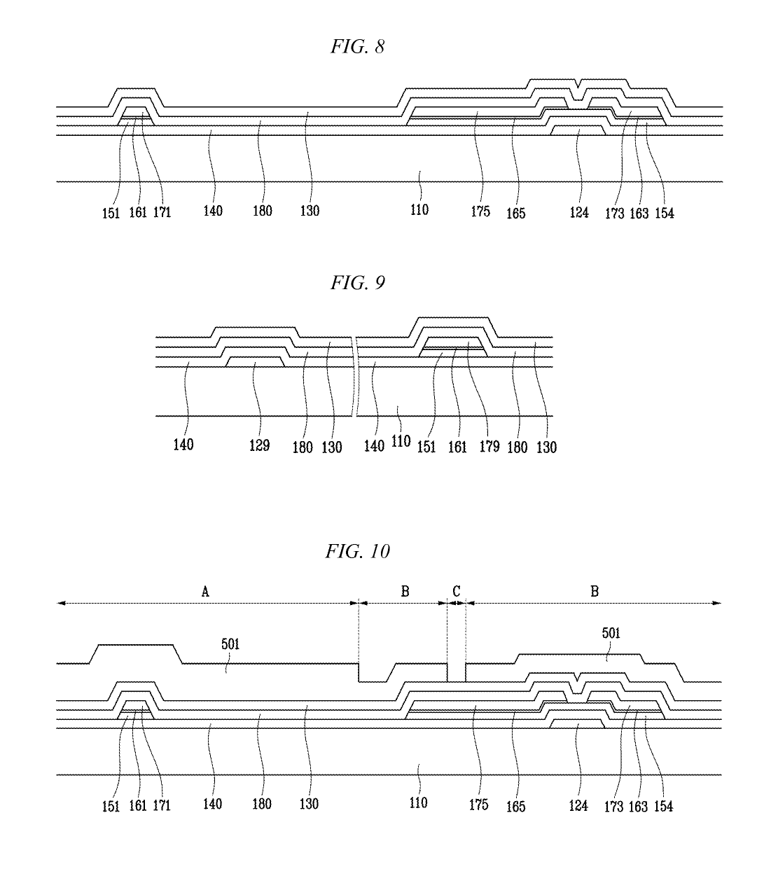

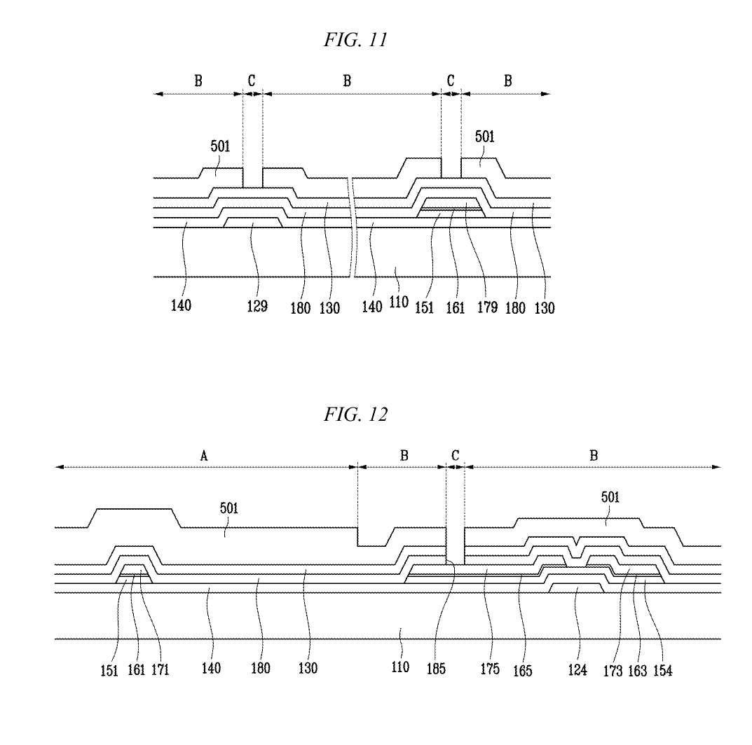

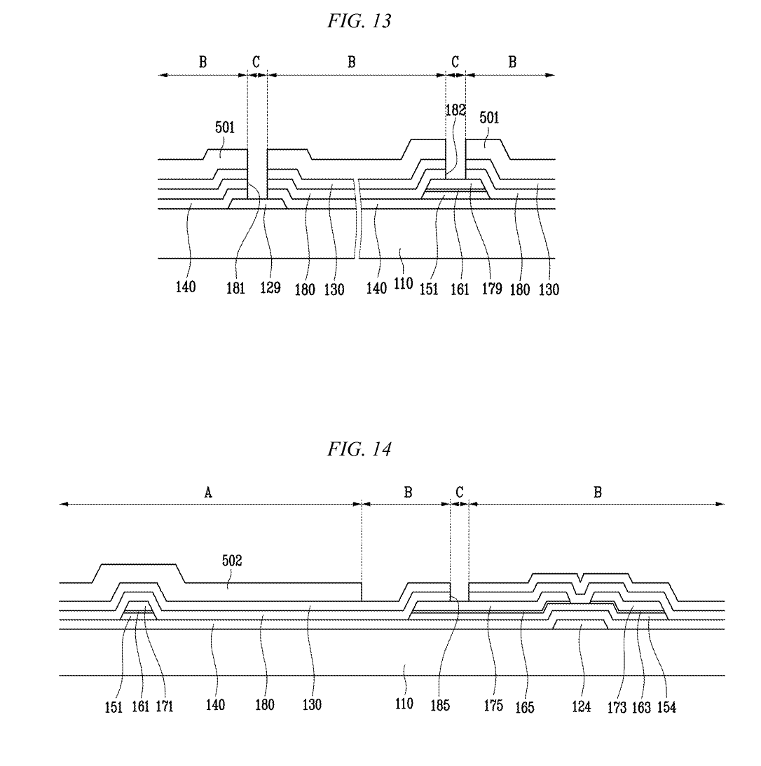

Hereinafter, a method for manufacturing an electrophoretic display according to an exemplary embodiment of the present invention will be described with reference to FIG. 4 to FIG. 19.

FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, and FIG. 19 are cross-sectional views of a manufacturing method for a thin film transistor array panel 100 of the electrophoretic display illustrated in FIG. 1.

First, as shown in FIG. 4 and FIG. 5, a conductive layer made of a single layer or multi-layered structure including chromium is deposited using sputtering on an insulation substrate 110 made of glass or plastic, and is patterned using photolithography to form gate lines 121 including gate electrodes 124 and end portions 129.

Next, silicon nitride (SiNx) or silicon oxide (SiOx) is deposited using plasma enhanced chemical vapor deposition (PECVD) to form a gate insulating layer 140 covering the gate lines 121.

Next, as shown in FIG. 6 and FIG. 7, intrinsic amorphous silicon (a-Si) not doped with an impurity and extrinsic amorphous silicon (n+ a-Si) doped with an impurity are sequentially deposited using PECVD, and a conductive layer made of a single layer or a multi-layered structure including chromium is deposited to form a data metal layer.

Next, the conductive layer, the extrinsic amorphous silicon layer, and the intrinsic amorphous silicon layer are patterned using photolithography including a half-tone mask to form semiconductor lines 151, the ohmic contact lines 161 and the ohmic contact islands 165, data lines 171 including source electrodes 173, and drain electrodes 175. The half-tone mask includes translucent areas that transmit a portion of light as well as transparent areas that transmit light and light blocking areas that block light. The translucent areas may have slit pattern or a lattice pattern, or may be one or more thin films with intermediate transmittance or intermediate thickness. When using a slit pattern, the width of the slits or the distance between the slits may be smaller than the resolution of a light exposer used for the photolithography.

This will be described below in more detail.

First, a photosensitive film is formed on the data metal layer, and then exposed and developed using the half-tone mask.

The developed photoresist film may include a first portion corresponding to the data lines 171 including the source electrodes 173 and drain electrodes 175, a second portion having a thinner thickness than the first portion and corresponding to the channel areas between the source electrode 173 and drain electrode 175, and a third portion where the photoresist film is almost removed such that a portion of the data metal layer is exposed.

Next, the conductive layer, the extrinsic amorphous silicon layer, and the intrinsic amorphous silicon layer are patterned using the developed photoresist film as an etch mask to first form semiconductor lines 151, extrinsic semiconductors, and data patterns.

Next, the developed photoresist film is ashed to form a second photosensitive film by removing the second portion and exposing the portions of the data patterns.

Next, the data patterns and the extrinsic semiconductors are patterned using the second photosensitive film as an etch mask to form data lines 171 including source electrodes 173 and drain electrode 175, and ohmic contact lines 161 and the ohmic contact islands 165 thereunder.

Next, as shown in FIG. 8 and FIG. 9, a passivation layer 180 and a transparent conductive layer 130 are sequentially deposited on the gate insulating layer 140, the data lines 171 including the source electrodes 173, the drain electrodes 175, and the exposed semiconductor lines 151. Here, the passivation layer 180 may be made of silicon nitride (SiNx) or silicon oxide (SiO2) with a single layer or multi-layered structure, and the transparent conductive layer 130 may be made of a transparent conductive material such as ITO or IZO.

Next, as shown in FIG. 10 and FIG. 11, a photosensitive film is formed on the transparent conductive layer 130, and exposed and developed using a half-tone mask (not shown) to form a first photosensitive film 501 having different thicknesses according to position. The first photosensitive film 501 includes first portions A corresponding to the position of the storage electrodes 131 as shown in FIG. 1, second portions B having a thinner thickness than the first portions A, and third portions C corresponding to the positions of the contact holes 181, 182, and 185 as shown in FIG. 1. The photosensitive film in the third portions C may be removed.

Next, as shown in FIG. 12 and FIG. 13, the transparent conductive layer 130 and the passivation layer 180 are etched using the first photosensitive film pattern 501 as an etch mask to form contact holes 181, 182, and 185. Here, the thickness of the first photosensitive film 501 may be reduced.

Next, as shown in FIG. 14 and FIG. 15, the first photosensitive film pattern 501 is ashed until the second portions B of the first photosensitive film 501 are removed to form the second photosensitive film 502 corresponding to first portions A of the first photosensitive film 501.

Next, as shown in FIG. 16 and FIG. 17, the transparent conductive layer 130 is etched using the second photosensitive film pattern 502 as an etch mask to form storage electrodes 131, and then the second photosensitive film pattern 502 is removed.

As above-described, the contact holes 181, 182, and 185 and the storage electrodes 131 are formed through the photolithography process using one half-tone mask such that the manufacturing process may be simplified.

Next, as shown in FIG. 18 and FIG. 19, a photosensitive organic material including pigments is repeatedly coated, and is exposed and developed to form color filters 230 having red R, green G, and blue B colors. Here, the color filters 230 are removed at the circumference of the display area, which may be referred to as a peripheral area corresponding to the end portions 129 and 179 of the gate lines 121 and the data lines 171, respectively. The color filters 230 are also removed to form contact holes 235 that expose the contact holes 185. The sequence of red R, green G, and blue B color filters 230 may be changed.

Next, a transparent conductive material such as ITO or IZO is sputtered on the color filters 230, and patterned through photolithography to form pixel electrodes 191 and contact assistants 81 and 82. The pixel electrodes 191 are connected to the drain electrodes 175 through the contact holes 235 and 185, and the contact assistants 81 and 82 are respectively connected to the end portions 129 and 179 of the gate lines 121 and the data lines 171.

To complete a common electrode panel 200, an opaque conductive layer made of a metal such as chromium is deposited on an insulation substrate 210 made of glass or plastic, and patterned to form a common electrode 270.

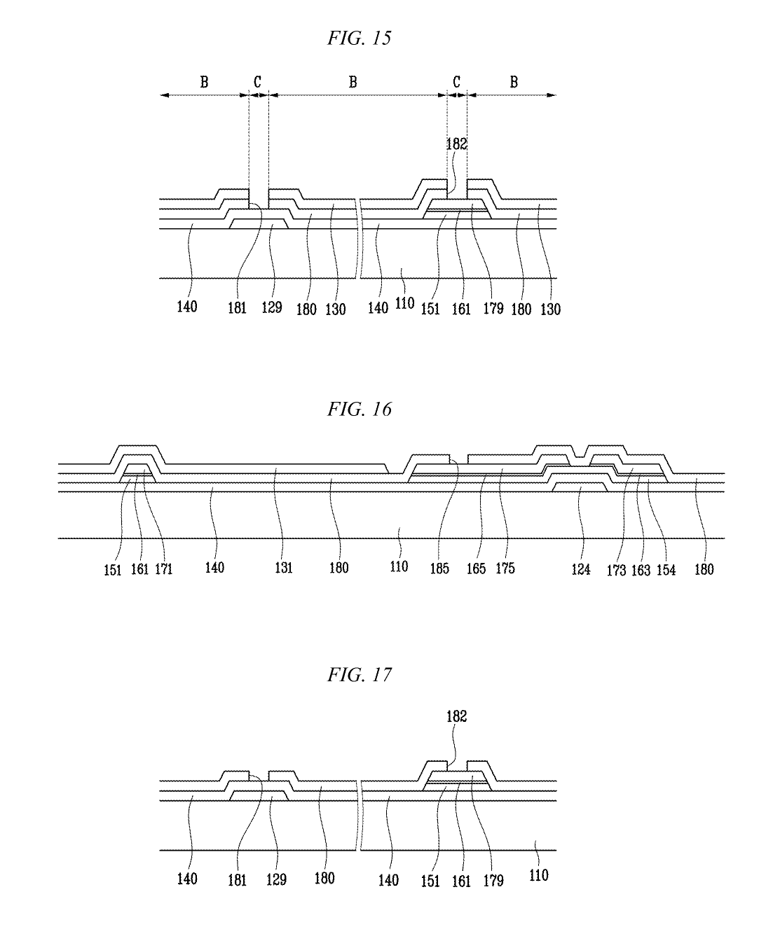

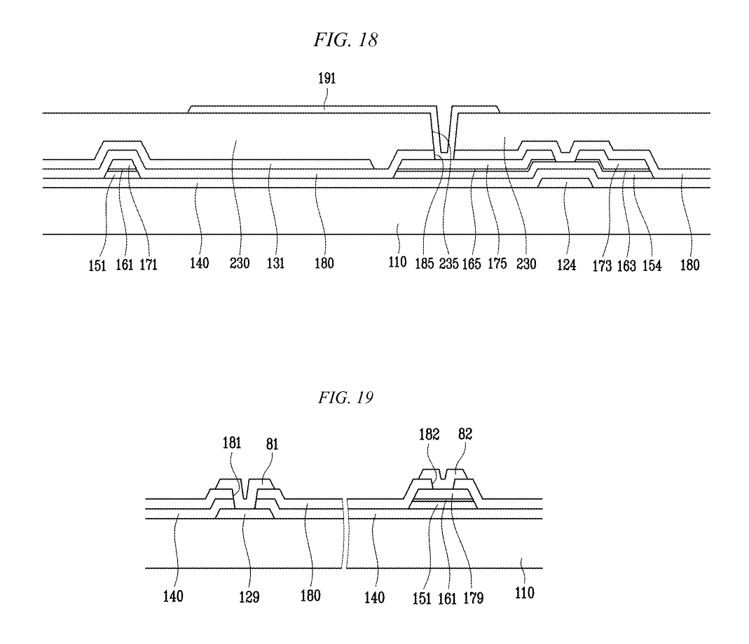

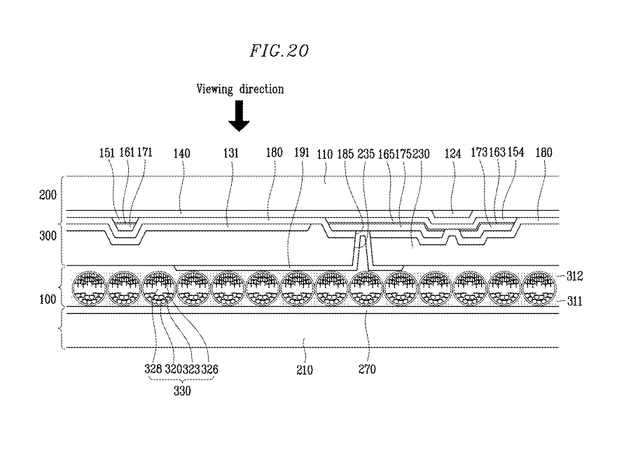

Next, as shown in FIG. 20, a first adhesion member 311 is formed on the common electrode 270 for adhering electrophoretic members 330 to the common electrode 270, and the first adhesion member 311 may be a liquefied material or a film.

Next, the electrophoretic members 330 are densely formed on the first adhesion member 311 by using a nozzle.

Next, a second adhesion member 312 is formed on the electrophoretic members 330. The second adhesion member 312 may be a liquefied material or a film.

Protecting sheets (not shown) may be mounted in or removed from the second adhesion member 312. The protecting sheets may protect the electrophoretic members 330 in the discontinuous manufacturing process of the electrophoretic display.

Next, the pixel electrodes 191 of the thin film transistor array panel 100 are adhered to the second adhesion member 312 to connect the thin film transistor array panel 100 to the electrophoretic members 330. If the protecting sheet is formed on the second adhesion member 312, the thin film transistor array panel 100 may be attached to the second adhesion member 312 after removing the protecting sheet.

Here, the process of adhering the thin film transistor array panel 100 on the electrophoretic members 330 may be executed in a vacuum environment with heat and pressure to prevent bubbles from forming in the second adhesion member 312. Furthermore, the electrophoretic members 330 are spread on all sides by the pressure of the adhering process such that the electrophoretic film 300 has a substantially uniform distribution and thickness.

As shown in FIG. 20, when the module process of the electrophoretic display according to the present invention is executed, the thin film transistor array panel 100 and the common electrode panel 200 are disposed to display the images by the thin film transistor array panel 100. That is, the thin film transistor array panel 100 is disposed on the side of the viewing direction such that the thin film transistor array panel 100 is used as a screen.

### Exemplary Embodiment 2

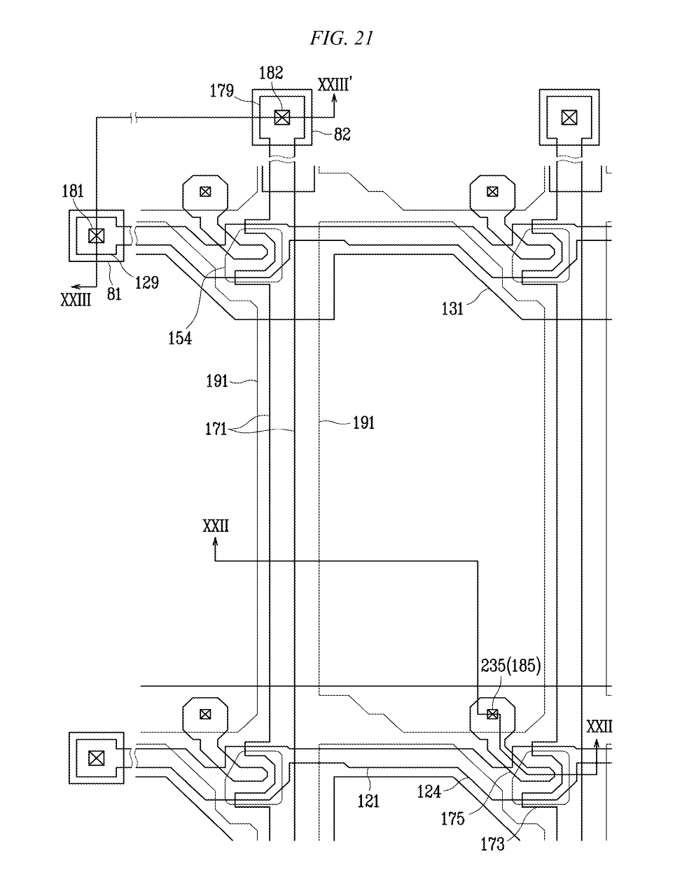

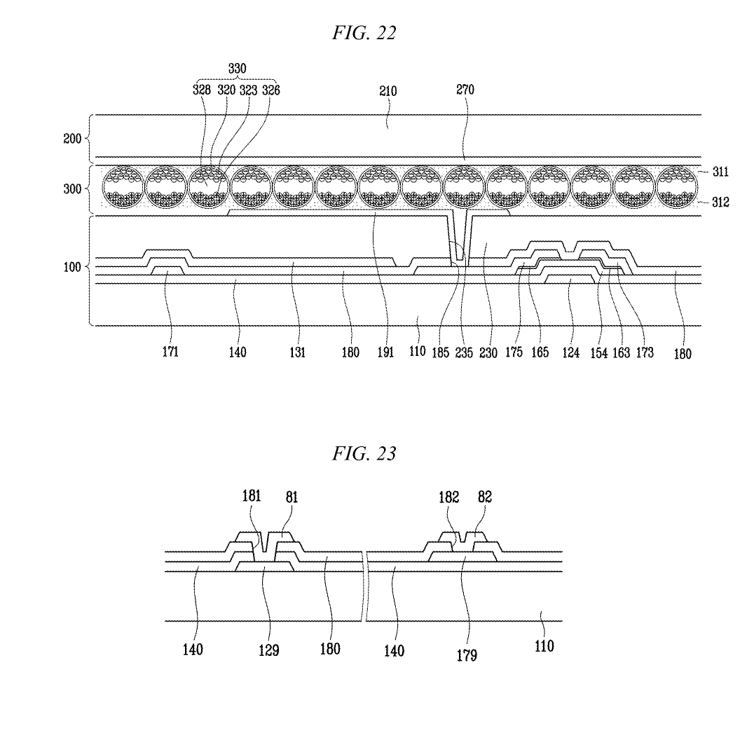

FIG. 21 is a plan view of an electrophoretic display according to another exemplary embodiment of the present invention. FIG. 22 is a cross-sectional view of the electrophoretic display illustrated in FIG. 21 taken along line XXII-XXII′. FIG. 23 is a cross-sectional view of the electrophoretic display illustrated in FIG. 21 taken along line XXIII-XXIII′.

As shown in FIG. 21 to FIG. 23, in an electrophoretic display according to another exemplary embodiment, semiconductors 154 are island-shaped, and only ohmic contacts 163 and 165 are arranged between the island-shaped semiconductors 154 and the source electrodes 173 and drain electrodes 175, except in a region corresponding to a channel region between the source electrodes 173 and the drain electrodes 175 where the ohmic contacts 163 and 165 are not formed.

In a method for manufacturing an electrophoretic display according to another exemplary embodiment, the semiconductors 154 and the ohmic contacts 163 and 165, and the data lines 171 and the drain electrodes 175, are patterned through different photolithography steps. Here, the semiconductors 154 may have a line shape according to the data lines 171 as in the previous embodiment, but because the data lines 171 and the semiconductors 154 are patterned, the planar shape of the data lines 171 may be different than that of the semiconductors 154.

A method for manufacturing the thin film transistor array panel 100 according to the exemplary embodiment shown in FIG. 21 to FIG. 23 will now be described in more detail.

First, a conductive layer including chromium is deposited on an insulation substrate 110 and patterned to form gate lines 121 including gate electrodes 124 and end portions 129.

Next, a gate insulating layer 140, an intrinsic amorphous silicon (a-Si) layer (not shown), and an extrinsic amorphous silicon (n+ a-Si) layer (not shown) are sequentially deposited on the gate lines 121, and the extrinsic amorphous silicon and intrinsic amorphous silicon are patterned by photolithography to form island-shaped semiconductors 154 and ohmic contact members (not shown).

Next, a conductive layer including chromium is deposited on the ohmic contact members, and patterned by photolithography to form data lines 171 including source electrodes 173 and drain electrodes 175.

Then, the ohmic contact members are etched by using the source electrodes 173 and the drain electrodes 175 as an etch mask to form ohmic contacts 163 and 165.

The description of the rest of the manufacturing process is the same as or substantially similar to that described above with reference to FIG. 8 to FIG. 19.

As above-described, the gate lines and the data lines are made of a conductive material having good light blocking characteristics, thereby replacing the light blocking layer, and the storage electrodes are made of a transparent conductive material thereby improving the aperture ratio. Also, the color filters are formed on the thin film transistor array panel such that the common electrode panel and the thin film transistor array panel may be easily aligned. Accordingly, an electrophoretic display having excellent display performance such as improved luminance and improved color image display may be provided.

Furthermore, because the gate lines and the data lines may replace the light blocking layer, an additional light blocking layer is not necessary, and the gate lines and the data lines may be used as a black matrix.

Further, because the storage electrode and passivation layer are formed by using one mask, the manufacturing process may be simplified.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An electrophoretic display, comprising:
a thin film transistor array panel, comprising:
a first insulating substrate,
a gate line arranged on the first insulating substrate and comprising a gate electrode,
a gate insulating layer arranged on the gate line,
a semiconductor arranged on the gate insulating layer,
a data line comprising a source electrode and a drain electrode, the data line arranged on the semiconductor or the gate insulating layer,
a passivation layer covering the data line and comprising a first contact hole exposing the drain electrode,
a storage electrode arranged on the passivation layer,
a color filter arranged on the storage electrode and comprising a second contact hole exposing the drain electrode through the first contact hole, and
a pixel electrode arranged on the color filter and connected to the drain electrode;
a common electrode panel, comprising:
a second insulating substrate facing the thin film transistor array panel, and
a common electrode arranged on the second insulating substrate; and
an electrophoretic member arranged between the pixel electrode and the common electrode.

2. The electrophoretic display of claim 1, wherein an image is displayed on the side of the thin film transistor array panel.

3. The electrophoretic display of claim 2, wherein external light is incident to the side of the thin film transistor array panel and the image is displayed through the thin film transistor array panel according to movement of particles in the electrophoretic member.

4. The electrophoretic display of claim 1, wherein the storage electrode comprises a transparent conductive layer.

5. The electrophoretic display of claim 4, wherein the storage electrode overlaps 30% to 90% of the pixel electrode.

6. The electrophoretic display of claim 5, wherein the thickness of the storage electrode is in a range of 50 to 3000 angstroms.

7. The electrophoretic display of claim 1, wherein the gate line and the data line each comprise at least one thin film made of an opaque metal.

8. The electrophoretic display of claim 7, wherein the opaque metal comprises chromium.

9. The electrophoretic display of claim 1, wherein the common electrode comprises an opaque metal.

10. The electrophoretic display of claim 9, wherein the opaque metal comprises chromium.

11. The electrophoretic display of claim 1, wherein the semiconductor is disposed between the first insulating substrate and the source electrode and the drain electrode, and has an island shape, and
the electrophoretic display further comprises ohmic contacts arranged between the source electrode and the semiconductor and between the drain electrode and the semiconductor.

12. The electrophoretic display of claim 1, wherein the passivation layer and the gate insulating layer comprise a third contact hole exposing a portion the gate line, and the passivation layer comprises a fourth contact hole exposing a portion of the data line, and
the electrophoretic display further comprises contact assistants arranged on the passivation layer and connected to the gate line and the data line through the third contact hole and the fourth contact hole, respectively.

13. A method for manufacturing an electrophoretic display, comprising:
forming a thin film transistor array panel, comprising:
forming a gate line, a semiconductor, and a data line on a first insulating substrate,
forming a passivation layer and a storage electrode, the passivation layer to cover the data line,
forming a color filter on the passivation layer and the storage electrode, and
forming a pixel electrode on the color filter;
forming a common electrode panel, comprising:
forming a common electrode on a second insulating substrate; and
depositing an electrophoretic member on the common electrode; and
connecting the common electrode panel to the thin film transistor array panel.

14. The method of claim 13, wherein external light is incident to the thin film transistor array panel, and an image is displayed through the thin film transistor array panel according to movement of particles in capsules of the electrophoretic member.

15. The method of claim 13, wherein forming the passivation layer and the storage electrode comprises:
sequentially depositing the passivation layer and a transparent conductive layer;
forming a first photosensitive film pattern comprising a first portion and a second portion having a thicker thickness than the first portion by using a half-tone mask on the transparent conductive layer;
etching the transparent conductive layer and the passivation layer by using the first photosensitive film pattern as an etch mask;
ashing the first photosensitive film pattern to remove the first portion and to form a second photosensitive film pattern; and
etching the transparent conductive layer by using the second photosensitive film pattern as an etch mask to form the storage electrode.

16. The method of claim 15, wherein etching the transparent conductive layer and the passivation layer by using the first photosensitive film pattern as the etch mask further comprises:
forming a plurality of contact holes to expose an end portion of the gate line, an end portion of the data line, and a drain electrode,
and
forming the pixel electrode further comprises:
forming a first contact assistant and a second contact assistant respectively connected to the end portion of the gate line and the end portion of the data line.

17. The method of claim 13, wherein forming the gate line, the semiconductor, and the data line on the first insulating substrate comprises:
forming the gate line on the first insulation substrate;
sequentially depositing the gate insulating layer, an intrinsic amorphous silicon layer, and an extrinsic amorphous silicon layer;
etching the extrinsic amorphous silicon layer and the intrinsic amorphous silicon layer by photolithography to form an ohmic contact member and the semiconductor;
forming the data line and the drain electrode on the ohmic contact member; and
etching the ohmic contact member between the source electrode and the drain electrode to form ohmic contacts.

18. The method of claim 13, wherein forming the gate line, the semiconductor, and the data line on the insulating substrate comprises:
forming the gate line on the insulating substrate;
sequentially depositing the gate insulating layer, an intrinsic amorphous silicon layer, an extrinsic amorphous silicon layer, and a data metal layer on the gate line;
forming a third photosensitive film pattern including a third portion and a fourth portion on the data metal layer, the fourth portion having a thickness that is greater than a thickness of the third portion;
etching the data metal layer, the extrinsic amorphous silicon layer, and the intrinsic amorphous silicon layer using the third photosensitive film pattern as an etch mask to form a data metal pattern, an ohmic contact member, and the semiconductor;
ashing the third photosensitive film pattern to remove the third portion and to form a fourth photosensitive film pattern; and
etching the data metal pattern and the ohmic contact member using the fourth photosensitive film pattern as an etch mask to form the data line, a drain electrode, and ohmic contacts.

19. A display device, comprising:
a first substrate, comprising:
a thin film transistor,
wherein the thin film transistor comprises a gate line comprising a gate electrode, a gate insulating layer arranged on the gate line, a semiconductor arranged on the gate insulating layer, a data line comprising a source electrode and a drain electrode;
a passivation layer covering the data line and comprising a first contact hole exposing the drain electrode,
a storage electrode arranged on the passivation layer, a color filter arranged on the storage electrode and comprising a second contact hole exposing the drain electrode through the first contact hole, and
a pixel electrode arranged on the color filter and connected to the drain electrode;
a second substrate, comprising:
a common electrode arranged on the second substrate,
wherein the second substrate is faced with the first substrate; and
an electrophoretic member arranged between the pixel electrode and the common electrode.
